(19) United States
(12) Patent Application Publication
(10) Pub. No.: US 2013/0219986 A1
(43) Pub. Date: Aug. 29, 2013

(54) METHOD AND APPARATUS FOR CALIBRATING A FLOW METER

(71) Applicants: Ville Laukkanen, Espoo (FI); Risto Kuoppamäki, Espoo (FI)

(72) Inventors: Ville Laukkanen, Espoo (FI); Risto Kuoppamäki, Espoo (FI)

(73) Assignee: OY INDMEAS AB, Espoo (FI)

(21) Appl. No.: 13/819,633

(22) PCT Filed: Aug. 23, 2011
(86) PCT No.: PCT/FI2011/050735

§ 371 Date: May 2, 2013

(30) Foreign Application Priority Data
Aug. 31, 2010 (FI) 20105918

(51) Int. Cl. G01F 25/00

(52) U.S. Cl. CPC G01F 25/0023
USPC 73/1.24

(57) ABSTRACT

In the method for calibrating a flow meter, at least two acoustic sensors are arranged at a distance to each other on a straight measuring portion, and a tracer is fed into the fluid flowing in the process pipe at a set mixing distance from the first measuring point. The momentary reference value of the flow velocity of the flowing fluid is measured by determining the travel time of the acoustic tracer between at least two sensors on the same straight measuring portion, by using the acoustic sensors to detect the relative content response of the tracer. This measured value can be compared with the value displayed by the flow meter. The mixing distance of the tracer is arranged to be at least long enough for the tracer to have effectively mixed at the first measuring point over the entire cross-section of the flow path of the fluid.

The present invention relates to a method and arrangement, according to the independent Claims, for calibrating a flow meter, particularly in production conditions and without interfering with the operation of the system comprising the meter.

The present invention relates to the calibration of industrial-scale flow meters in the field, by using a travel-time method in the flow in a pipe or corresponding flow channel.

Flow meters are used usually to measure the velocity of a liquid or gas flow in a pipe. There are numerous different types of flow meter, but they all have in common a tendency to be subject to disturbances caused by installation-site conditions, such as different flow profiles, vibrations, and temperature variations. Installation-site conditions can even induce large systematic errors in meters, though in laboratory conditions the meters might operate faultlessly within the parameters of their specifications. Therefore, there is a need to calibrate flow meters under installation-site conditions, so that the disturbances caused by them can be taken into account in calibration. If there has been a need for calibration, industrial-scale flow meters (roughly pipe size>DN100 and flow>10 m3/h) have been detached from the pipework and sent to a laboratory to be calibrated. This is extremely laborious and the pipework must be cut for the duration of the operation. In addition, the effect of the measurement-site conditions cannot be taken into account.

Besides laboratory calibration, several field-calibration methods have been developed, but so far these have been applied in very few cases world-wide. One method applicable to field calibration is the travel-time method according to ISO-2975/VI and ISO-2975/VII (‘Measurement of water flow in closed conduits-tracer methods’), in which a short pulse of a tracer is fed into the flow to be measured, the travel time of which over a straight portion between two points is defined. The volume is measured as the result of the mean flow velocity and the pipe's cross-sectional area. The flow value obtained is compared with that displayed simultaneously by the flow meter. Several tracing-agent feeds are made at the same flow level and the calibration result is obtained as the mean value of the test repeats.

A special feature of the travel-time method is that the speed of travel of the tracer is defined over a long flow journey. The measurement method itself then gives as the result an estimate of the mean flow velocity. In other words, the measurement result is largely independent of the flow profile. The travel-time method standard lays down two tracer classes for use: radioactive substances and non-radioactive substances, such as salts or colouring agents. Radioactive tracers can be detected easily from the outer surface of the pipe and with their aid the measurement can be implemented in such a way that the dependence of the measurement result on the flow profile can be practically eliminated. A drawback of radioactive tracers is that they demand extensive training in their use, which is always dependent on permits and relatively expensive, and they are unsuitable for use in the foodstuffs industry or in drinking-water networks. Nowadays, the use of radioactive substances has been almost entirely given up, due to the difficulties relating to their use and to their questionable environmental reputation.

For their part, non-radioactive substances have the advantages of a low price and the fact that their use requires no particular safety training. However, salts and colouring agents in small concentrations cannot be detected from outside a pipe and it is often difficult to make process connections at precisely the desired locations in industrial conditions. In addition, possible sampling causes a significant additional uncertainty. In many processes, it is also not possible or permitted to add any extraneous substance.

Non-radioactive substances can also be detected from the external surface of a pipe using ultrasound and microwave techniques. Continuously operating flow-measurement devices based on these phenomena are also known, for example, from publications U.S. Pat. No. 7,270,015B1, JP2004184177A, and U.S. Pat. No. 7,424,366B. A problem with these measuring devices designed for continuous operation is that, in order to function, they demand a heterogeneous process fluid changing as a function of time, they are designed for laboratory size-class flows, or, if they are altered for an industrial environment, they would require permanent alterations to the pipework. In addition, permanently installed meters have physical size limitations, so that a long straight measuring portion cannot be used with them, making them liable to profile disturbances and unable to be used for calibration purposes. These measuring devices, which are mostly based on correlation, are also mainly suitable for the measurement of extremely small flows, for example, in medical applications. One significant defect in the calibration technologies known at present is that they are not suitable for the field calibration of large industrial-scale flow measurements in the foodstuffs-industry and drinking-water networks. One reason for this is that the pulse formed in these methods travels inside the flow, and does not mix over the entire flow cross-sectional area, so that the measurement only concerns a specific point in the cross-sectional area of the flow. In small pipes, this is not necessarily of great importance, as the flow velocity can remain sufficiently constant over the cross-sectional area. Thus, in pipes with a small, cross-sectional area, a sufficiently accurate measurement result may be obtained. A small thermal resistance situated inside the pipe can therefore be sufficient to create a measuring pulse. In industrial-scale pipes, on the other hand, the flow velocity can vary even greatly over the cross-sectional area, so that the point in the cross-sectional area at which the detecting pulse travels is of great importance in terms of the measurement result In addition, in great flow amounts, a low heating power or small amount of tracer will not create a proper measuring pulse. Thus, at present no sufficiently practicable method exists for calibrating flow meters in field, i.e. production conditions.

The present invention is intended to create a method and arrangement, with the aid of which flow meters can be calibrated in production conditions for large flows, without substantially disturbing the flow.

One embodiment of the invention is intended to create a method that can be applied in all flowing substances, which are gas, liquid, combinations of these, and mixtures of these and solids particles.

One embodiment of the invention is intended to create a method, in which there is no need to feed any tracer that is external to the process.

The invention is particularly intended to create a method, by means of which a flow-measurement result with a known measurement uncertainty can be obtained, so that the result can be used in the on-site calibration of industrial-scale flow meters.

The invention is based on measuring a momentary reference value for the flow velocity of a flowing fluid, by determining the travel time of an acoustic tracer between at least two measurement points on the same straight measuring portion, by using acoustic detectors to detect the tracer. The tracer is mixed with the flowing fluid at a defined mixing distance from the first mixing point, which mixing distance must be at least long enough for the tracer to be effectively mixed with the fluid over the entire cross-sectional area of the flow path.

One embodiment of the invention is based on the distance between at least two measuring points being so large that the combined measurement precision of the detectors is not significant, compared to the length of the measured flow time.

One embodiment of the invention is based on a flowing fluid, the temperature of which is altered before it is mixed into the process flow to be measured, being used as the tracer.

More specifically, the invention is characterized by what is stated in the characterizing parts of the independent Claims.

Considerable advantages are gained with the aid of the invention.

The method retains the advantage of the traditional travel-time method, in other words that its use gives an extremely accurate momentary flow velocity, making it pre-eminently suitable for calibration. The method neither disturbs the operation of the meter being calibrated, nor requires alterations in industrial processes, such as instrumentation that increases pressure losses. All the devices used in the measurement can be installed and dismantled while the normal process is running. In addition, there is not necessarily any need to add any external substance, instead a heat pulse can also act as the acoustic tracer, making it suitable for use, for instance, in the foodstuffs industry and water-mains networks.

With the aid of the invention, considerable advantages are obtained in the process industry's control of the amounts of substances and in determining energy consumption. In the process industry, considerable energy flows travel in various pipe networks and in other flow channels, which are difficult to measure. Because flow measurement concerns measurement of both the amount of a substance passing a defined cross section and the amount of energy it contains, a flow measurement is required in nearly all determining of the amount of a flowing substance and the energy amount. Thus, the reliable and accurate calibration of flow meters is of primary importance to the adjustment and monitoring of processes. Because calibration can be performed during a normal production process, the calibration is fitted exactly to the operating range of the meter and systematic errors due to the environment are included in the measurement result.

In the following, the invention is described in greater detail with the aid of the accompanying drawings.

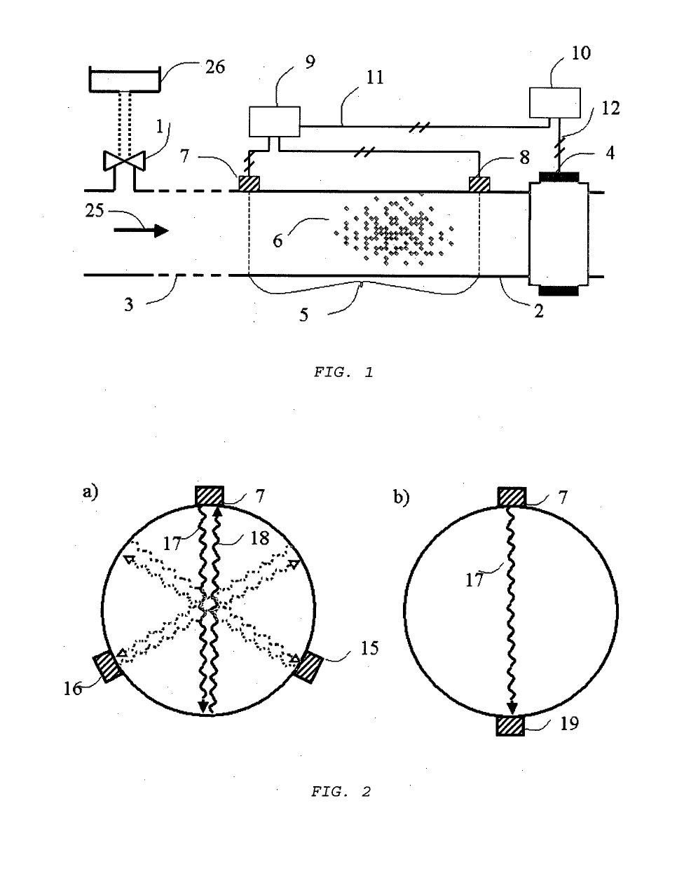

FIG. 1 shows a schematic diagram of one arrangement according to the invention, installed in process pipework.

FIGS. 2a and 2b show schematically different ways of using acoustic sensor.

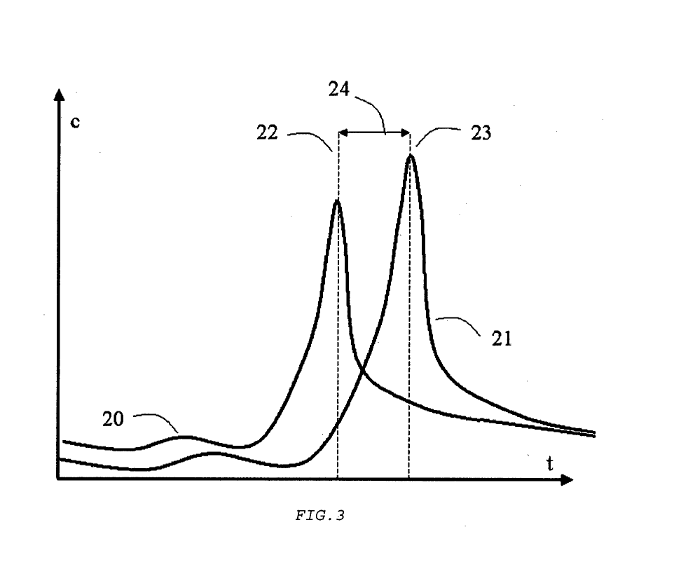

FIG. 3 is a schematic diagram of the detection of a measuring pulse, detected using two sensors.

The example of FIG. 1 shows a calibration solution according to the invention, for calibrating a water meter. The calibration arrangement comprises a process-equipment portion, which includes a process pipe 2 in the example of FIG. 1, in which the flow velocity of the process fluid 25 is examined. A flow meter 4, from which a signal conductor 12 transmitting the measurement value to the process calculation computer 10 starts, is fitted to the process pipe 2. The process equipment also includes a feed connection 1, which can be any connection whatever, for example, a connection of a pressure meter or some other device, at at least a mixing distance 3 (marked with broken lines) from the measuring location. If necessary, such a connection 1 can be easily installed in a suitable location in the pipework.

The calibration portion comprises a group of two acoustic sensors 7, 8, which are located at a distance, i.e. at the ends of the measuring straight portion 5, from each other. The signal conductors lead from the acoustic sensors 7, 8 to the computation unit, which is connected by a line 11 to the calculation computer 12. A reservoir 26, in which the measuring process fluid, i.e. in this case water, can be advantageously located, is connected to the connection 1 at the measuring distance 3 from the first sensor group 7, for feeding the tracer 6. In this way, the process cannot be contaminated in any way. In order to create detection, the tracer (the process fluid in the reservoir) is heated (or cooled) by means of devices in connection with the reservoir, so that its acoustic properties change and the dosed pulse can be detected.

Ways of installing the sensor are shown in FIGS. 2a and 2b. The sensors can be installed in the pipe, either in such a way that the same sensor 7 transmits a signal 17 and receives the reflected signal 18 (configuration 2a), or in such a way that a separate sensor 19 is installed on the other side of the pipe to receive the signal 17 directly (configuration 2b). It is good if there are several sensors at the same measuring point (FIG. 2a, sensors 7, 15, 16), so that they can be used to further reduce the effect of the flow profile on the measurement result.

The calibration according to the invention functions in the following manner.

In the invention, the tracing-agent method and the acoustic measuring technique are combined to form a method, with the aid of which industrial-scale can be calibrated without the previous applicability restrictions. A tracer altering the acoustic properties of the flowing liquid is fed in impulses through the feed connection 1 to the process pipe 2. A substance, in which the speed of sound is different to that in the process fluid, can act, for example, as the tracer 6. Over the mixing distance, the tracer disperses evenly over the entire cross-sectional area of the pipe. This is essential in terms of the calculations of the uncertainty of the measurement result, so that the mixing distance should be long enough for the tracer to have effectively mixed over the entire cross-sectional area of the flow path of the fluid.

The mixing distance is stated in pipe diameters. If the mixing distance consists of only a straight portion of pipe, the mixing distance should be at least 100 times the pipe diameter. Mixing is increased by the components; pumps, pipe bends, throttle valves, flanges, tracing-agent multi-point feed, etc. shorten the mixing distance required. The mixing distance must be defined separately for each flow path and it can be preferably longer that the minimum distance.

The travel time and reference flow velocity of the tracer between two points on the measuring straight portion are determined with the aid of acoustic sensors 7, 8 installed temporarily outside the pipe 2 and of computation unit 9. The volume flow is measured as the product of the measured mean flow velocity and the cross-sectional area of the pipe. The flow value obtained is compared to that displayed simultaneously by the flow meter 4 in the calculation computer 10. The flow value obtained is compared to that displayed simultaneously by the flow meter 4. At the same time, several tracing-agent feeds are made at the same flow level and the calibration result is obtained as the mean value of the test repeats.

In FIG. 1, a tracer 6 altering the acoustic properties of the flowing fluid is fed in impulses through a feed connection 1 to the process pipe 2. Almost any already existing connection in the process, such as a pressure-sensor measuring connection, can act as the feed connection 1. A sample of the same process fluid, heated or cooled in a heating cylinder 26 temporarily connected to the process, for example, can, act as the tracer. The acoustic properties of the flowing agent are measured continuously using sensors 7 and 8. The acoustic property can be, for example, the speed of sound and its change in the flowing fluid. Because the sensors are capable of making hundreds of measurements a second, the detection of the time of arrival of the tracer at the sensor is precise.

The tracer 6 should be mixed over the cross-sectional area of the pipe over the mixing distance 3, before it arrives at the measuring straight portion 5. FIG. 3 shows the changes caused by the fed tracer 6 in the acoustic property being measured (c, speed of sound) at two different measuring points 20, 21. The tracing-agent pulse should be large enough relative to the normal background variations for the change caused to be reliably defined as a function of time, as i.e. the mean time of arrival at each sensor 22 and 23, and thus the travel time Δt, between the measuring points. The measuring points should be far enough from each other that the measurement uncertainties of the distance 5 between the sensors and the arrival times 22 and 23 of the tracing-agent pulses will not significantly affect the result. The recording frequency of the sensors should be at least ten times, preferably at least one hundred times that of the time taken by the measuring pulse between the measuring points, or rather on the contrary, the distance between the measuring points should be so large that time used by the pulse to travel over the measurement distance will be at least ten times the combined detection precision of the sensors, preferably considerably longer.

The volume flow (V) is obtained as the product of the mean flow velocity ( v̅) and the pipe's cross-sectional area (A), i.e. by dividing the internal volume (V) of the pipe between the measuring points by the tracing-agent's travel time (Δt) (equation 1).

$$\dot{V} = A \cdot \overline{v} = \frac{V}{Δ t}$$

The flow value obtained is compared with that of the flow meter displayed simultaneously in the calculation computer. Several tracing-agent feeds are made at the same flow level and the calibration result is obtained as the mean value of the test repeats.

The present invention has other embodiments in addition to those described above.

The measuring computer 10 or similar is a device, in which the value displayed 12 by the flow meter is compared to the flow velocity computed using the travel time 24 of the acoustic tracer. The acoustic tracer 6 used can be a sample of the process fluid 25, which is cooled or heated outside the process pipe, and which is fed in impulses back into the process. The acoustic tracer 6 can also be a substance that scatters or absorbs ultrasound, fed in impulses to the pipe 2. At the measuring points, the content of tracer is measured indirectly by measuring the acoustic properties of the fluid 25 using one or several ultrasound sensors. The acoustic tracer content is measured as a change in the speed in the process fluid of the ultrasound 17 that has travelled through the pipe, as attenuation of the signal of the ultrasound 17 that has travelled through the pipe, or from the scattering of the signal of the ultrasound 17 that has travelled through the pipe. This travel time of the acoustic tracer 6 is determined by measuring the relative content of the tracer as a function of time, by monitoring the acoustic properties of the ultrasound signal 17 that has travelled through the pipe, at at least two points 7-8 on the measuring straight portion 5 and by calculating the time delay 24 in the change in content between the points, in the computation unit 9. If desired, it is also possible to use several tracing-agent feed connections. The acoustic measurement can take place before or after the flow meter 4 being calibrated, in the direction of flow, as long as the measuring point is in the same pipe as the meter being calibrated.

1. A method for calibrating a flow meter, in which method:
arranging at least two acoustic sensors at a distance to each other are fitted to the process pipe at the ends of a measuring portion,
feeding a tracer into the fluid flowing in the process pipe, from a first measuring point at the distance of a defined mixing distance,
measuring a momentary reference value of the flow velocity of the flowing fluid is by determining the travel time of the acoustic tracer between at least two sensors on the same straight measuring portion, by using acoustic sensors to detect the relative content response of the tracer, and
comparing the measured value to the value displayed by the flow meter,
wherein
the mixing distance of the tracer is arranged to be at least long enough for the tracer to be effectively mixed with the fluid at the first measuring point, over the entire cross-sectional area of the flow path.

2. The method according to claim 1, wherein the distance between the two measuring points is at least great enough that the velocity value of the flow measured between them represents the mean flow velocity of the fluid.

3. The method according to claim 1, wherein the fluid flowing in the process being calibrated, the temperature of which is altered before it is fed into the process flow being calibrated, is used as the tracer.

4. The method according to claim 1, wherein the flowing fluid is a liquid, a gas, a combination of these, or any of these containing solids particles.

5. The method according to claim 1, wherein the value displayed by the flow meter is compared to the flow velocity calculated using the travel time of the acoustic tracer.

6. The method according to claim 3, wherein the acoustic tracer is a sample of the process fluid, cooled or heated outside the process pipe, which is fed in impulses back into the process.

7. The method according to claim 1, wherein the tracer is a substance that scatters or absorbs ultrasound, fed in impulses into the pipe.

8. The method according to claim 1, wherein at the measuring points, sensors are used to measure indirectly the content of the tracer, by measuring the acoustic properties of the fluid, using one or several ultrasound sensors.

9. The method according to claim 1, wherein the acoustic tracer content is measured as a change in the process fluid in the velocity of the ultrasound that has travelled through the pipe.

10. The method according to claim 1, wherein the acoustic tracer content is measured as the attenuation of the signal of the ultrasound that has travelled through the pipe.

11. The method according to claim 1, wherein the acoustic tracer content is measured from the scattering of the signal of the ultrasound that has travelled through the pipe.

12. The method according to claim 1, wherein the travel time of the acoustic tracer is determined by measuring the relative content of the tracer as a function of time, by monitoring, at at least two points on the straight measuring portion, the acoustic properties of an ultrasound signal that has travelled through the process pipe, and calculating, in the computation unit, the time delay in the content change between the points.

13. An arrangement for calibrating a flow meter, which comprises:
at least two acoustic sensors arranged at a distance to each other at the ends of a measuring portion which are fitted to the process pipe,
at least one connection for feeding tracer to the fluid flowing in the process pipe at a defined mixing distance after, in the direction of flow, the first measuring point,
elements for determining a momentary reference value of the flow velocity of the flowing fluid, in order to determine, by measurement, the travel time of the acoustic tracer between at least two sensors on the same straight measuring portion, by using the acoustic sensors to detect the tracer,
elements for comparing the measurement value with the value displayed by the flow meter,
wherein
a tracer is applied, the mixing distance of which is long enough for the tracer to be effectively mixed with the fluid at the first measuring point, over the entire cross-section of the flow path.

14. An arrangement according to claim 13. wherein an element for altering the temperature of the flowing fluid taken from the process.

15. An arrangement according to claim 13, wherein the distance between the at least two measuring points is arranged to be long enough that the velocity value of the flow measured between them will represent the mean flow velocity of the fluid.

16. The method according to claim 2, wherein the fluid flowing in the process being calibrated, the temperature of which is altered before it is fed into the process flow being calibrated, is used as the tracer.

17. The method according to claim 2, wherein the flowing fluid is a liquid, a gas, a combination of these, or any of these containing solids particles.

18. The method according to claim 3, wherein the flowing fluid is a liquid, a gas, a combination of these, or any of these containing solids particles.

19. The method according to claim 1, wherein the value displayed by the flow meter is compared to the flow velocity calculated using the travel time of the acoustic tracer.

20. The method according to claim 2, wherein the value displayed by the flow meter is compared to the flow velocity calculated using the travel time of the acoustic tracer.
